(19) United States
(12) Patent Application Publication
(10) Pub. No.: US 2026/0079854 A1
(43) Pub. Date: Mar. 19, 2026

(54) CONTROLLING ACCESS TO MEMORY LOCATIONS

(71) Applicants: Apple Inc., Cupertino, CA (US); Arm Limited, Cambridge (GB)

(72) Inventors: Alexander Donald Charles CHADWICK, Cambridge (GB); Jeff GONION, Campbell, CA (US); Bernard J. SEMERIA, Palo Alto, CA (US)

(21) Appl. No.: 19/325,328

(22) Filed: Sep. 10, 2025

Related U.S. Application Data
(60) Provisional application No. 63/696,006, filed on Sep. 18, 2024.

(51) Int. Cl. G06F 12/14

(52) U.S. Cl. CPC G06F 12/1483; G06F 12/1408; G06F 12/1441

(57) ABSTRACT

Apparatuses, methods, computer programs and computer-readable storage media are disclosed. An instruction associated with an instruction fetch address is fetched. In response to the instruction an operation defined by the instruction is conditionally performed. Values indicative of a current processing state of processing are held in registers comprising an execution context identifier register holding an execution context identifier indicative of a current process. A current region identifier is determined based on the instruction fetch address. A permissions index is determined based on the current region identifier and the execution context identifier. The permissions index is used to index into a permissions disabling table to determine a set of permission disables and whether or not the operation is prohibited is determined based on the set of permission disables.

This application claims the benefit of priority to U.S. Provisional App. Ser. No. 63/696,006, titled “CONTROLLING ACCESS TO MEMORY LOCATIONS,” filed on Sep. 18, 2024, which is incorporated herein by reference in its entirety.

### TECHNICAL FIELD

The present disclosure relates to data processing. In particular, the present disclosure relates to controlling whether operations defined by instructions are permitted to be performed.

### DESCRIPTION

A data processing apparatus that executes data processing instructions will typically execute a range of processes, where the code which runs for those processes can have a range of trustworthiness and privilege. Equally, in order to support a great diversity of functionality, the data processing apparatus may be provided with a large range of instructions and system registers. These two characteristics may not always be mutually compatible with one another, in that the most trusted code may be considered safe to access all instructions and system registers that are available, whilst it may be desirable to withhold some instructions and system registers from less trusted code.

### SUMMARY

In one example embodiment described herein there is an apparatus comprising:
instruction fetch circuitry responsive to an instruction fetch address to fetch an instruction associated with the instruction fetch address;
processing circuitry responsive to the instruction conditionally to perform an operation defined by the instruction;
register circuitry to hold values indicative of a current processing state of the processing circuitry, wherein the register circuitry comprises an execution context identifier register to hold an execution context identifier indicative of a current process which has caused the instruction to be fetched; and
security circuitry configured to:
   determine, based on the instruction fetch address, a current region identifier;
   determine, based on the current region identifier and the execution context identifier, a permissions index;
   use the permissions index to index into a permissions disabling table to determine a set of permission disables;
   determine, based on the set of permission disables, whether the operation is prohibited; and
   issue, in response to determining that the operation is prohibited, a response to the processing circuitry indicating that the operation is prohibited.

In one example embodiment described herein there is a method comprising:
fetching, in response to an instruction fetch address, an instruction associated with the instruction fetch address;
holding values in registers indicative of a current processing state, wherein the registers comprises an execution context identifier register to hold an execution context identifier indicative of a current process which has caused the instruction to be fetched;
conditionally performing, in response to the instruction, an operation defined by the instruction;
determining, based on the instruction fetch address, a current region identifier;
   determining, based on the current region identifier and the execution context identifier, a permissions index;
   using the permissions index to index into a permissions disabling table to determine a set of permission disables;
   determining, based on the set of permission disables, whether the operation is prohibited; and
   issuing, in response to determining that the operation is prohibited, a response to the processing circuitry indicating that the operation is prohibited.

In one example embodiment described herein there is a computer program for controlling a host data processing apparatus to provide an instruction execution environment, the computer program comprising:
instruction fetch program logic responsive to an instruction fetch address to fetch an instruction associated with the instruction fetch address;
processing program logic responsive to the instruction to perform an operation dependent defined by the instruction;
register program logic to hold values indicative of a current processing state of the processing circuitry, wherein the register circuitry comprises an execution context identifier register to hold an execution context identifier indicative of a current process which has caused the instruction to be fetched; and
security program logic configured to:
   determine, based on the instruction fetch address, a current region identifier;
   determine, based on the current region identifier and the execution context identifier, a permissions index;
   use the permissions index to index into a permissions disabling table to determine a set of permission disables;
   determine, based on the set of permission disables, whether the operation is prohibited; and
   issue, in response to determining that the operation is prohibited, a response to the processing program logic indicating that the operation is prohibited.

### BRIEF DESCRIPTION OF THE DRAWINGS

The present invention will be described further, by way of example only, with reference to embodiments thereof as illustrated in the accompanying drawings, in which:

FIG. 1 schematically illustrates a data processing apparatus embodying the present techniques in accordance with some examples;

FIG. 2 schematically illustrates a data processing apparatus embodying the present techniques in accordance with some examples;

FIG. 3 schematically illustrates a data processing apparatus embodying the present techniques in accordance with some examples;

FIG. 4 schematically illustrates a data processing apparatus embodying the present techniques in accordance with some examples;

FIGS. 5A and 5B schematically illustrate a permission disables table and example entries in accordance with some examples;

FIG. 6 schematically illustrates a data processing apparatus embodying the present techniques in accordance with some examples;

FIG. 7 schematically illustrates a look-up process using an instruction region table to yield a permissions index in accordance with some examples;

FIG. 8 schematically illustrates a data processing apparatus embodying the present techniques in accordance with some examples;

FIG. 9 is a flow diagram showing a sequence of steps which are taken in accordance with the method of some examples; and

FIG. 10 schematically illustrates a simulator implementation that may be used.

### DESCRIPTION OF EXAMPLE EMBODIMENTS

Before discussing the embodiments with reference to the accompanying figures, the following description of embodiments is provided.

In accordance with one example configuration there is provided an apparatus comprising:
instruction fetch circuitry responsive to an instruction fetch address to fetch an instruction associated with the instruction fetch address;
processing circuitry responsive to the instruction conditionally to perform an operation defined by the instruction;
register circuitry to hold values indicative of a current processing state of the processing circuitry, wherein the register circuitry comprises an execution context identifier register to hold an execution context identifier indicative of a current process which has caused the instruction to be fetched; and
security circuitry configured to:
   determine, based on the instruction fetch address, a current region identifier;
   determine, based on the current region identifier and the execution context identifier, a permissions index;
   use the permissions index to index into a permissions disabling table to determine a set of permission disables;
   determine, based on the set of permission disables, whether the operation is prohibited; and
   issue, in response to determining that the operation is prohibited, a response to the processing circuitry indicating that the operation is prohibited.

The sequences of instructions that the processing circuitry executes may correspond to the execution of a range of processes, where the code (sequence(s) of instructions) which runs for those processes can have a range of trustworthiness and privilege. Equally, in order to support a great diversity of functionality, the data processing apparatus may be provided with a large range of instructions and system registers. The present techniques recognise that these two characteristics may not always be mutually compatible with one another, in that the most trusted code may be considered safe to access all instructions and system registers that are available, whilst it may be desirable to withhold some instructions and system registers from less trusted code. Accordingly, whilst it is known for access to a memory location to be controlled on the basis of the process which is seeking access to that memory location (for example as defined by attribute information comprised in a page table entry, checked as part of an address translation process converting virtual to physical memory addresses), the present techniques provide mechanisms for withholding the ability to execute some instructions and to access some system registers. Accordingly, both a current region identifier (indicative of the section of code currently being executed) and an execution context identifier are used to determine a permissions index, which is used to index into a permissions disabling table to determine a set of permission disables. Note that execution context identifier is indicative of a current execution context within a current process that has caused the instruction to be fetched. Note that the use of “indicative of a current execution context” here means that the current execution context identifier does not necessarily precisely define the current context, but rather could be an element of the current context and thus provide information about the current context. This set of permissions disables that is determined is then used to determine whether the currently executing code/process will be permitted to execute certain instructions and to access certain system registers. In essence therefore, entries in the permissions disabling table allow certain actions to be blocked. Where the set of permissions disables is provided by a permissions disabling table, this provides flexibility in the configuration of those permissions disables, being modifiable on-the-fly, and being provided in as many different variants as there are entries in the table.

The permissions disabling table may be stored and accessed in a variety of locations. In some examples, the permissions disabling table is stored in memory and the security circuitry comprises table access circuitry to perform a look-up in the permissions disabling table in memory based on the permissions index to determine the set of permissions disables. In some examples the permissions disabling table is stored in one or more registers of the register circuitry and the security circuitry comprises table access circuitry to perform a look-up in the permissions disabling table in the one or more registers of the register circuitry based on the permissions index to determine the set of permissions disables.

The permissions disabling table may be provided in a variety of forms, but in some examples the permissions disabling table stores a set of entries indexed by the permissions index, wherein each entry in the permissions disabling table is a multi-bit value, wherein each bit of the multi-bit value corresponds to an individual permission disable of the set of permission disables. Thus a compact storage of the permissions disabling table is supported, whereby one multi-bit value (e.g. a byte) represents a number of individual permissions (turned on or off in dependence on a corresponding bit).

The determination of the permissions index based on the current region identifier and the execution context identifier may be performed in a variety of ways, but in some examples the security circuitry comprises table access circuitry to perform a look-up in an instruction region table in memory based on the current region identifier and the execution context identifier to determine the permissions index. This indirection of the determination via instruction region table in memory supports flexibility and dynamic configurability in the permissions index that is determined for a given current region identifier and execution context identifier combination.

The instruction region table may be variously structured, but in some examples the instruction region table is a one-dimensional table and the security circuitry is configured to concatenate the current region identifier and the execution context identifier to provide an index for the look-up in the instruction region table.

The permission disables of the set of permission disables can be arranged to disable any action based on any condition as appropriate to the system in which these techniques are implemented. In some examples at least one permission disable of the set of permission disables causes the operation to be determined to be prohibited, when the instruction is a predetermined type of instruction. Thus the use of particular instructions (for example that are recognised to be able to expose certain potential security vulnerabilities) can be prevented for certain combination of execution context identifier and current region identifier.

When the use of a particular instruction is prohibited in this manner, the apparatus may respond to an attempt to use that instruction (when prohibited) in a variety of ways. The instruction may effectively simply be ignored or an explicit response may be triggered. Thus in some examples, the security circuitry is responsive to the at least one permission disable of the set of permission disables causing the operation to be determined to be prohibited to initiate a prohibited instruction response. Such a prohibited instruction response may take a variety of forms. In some examples the prohibited instruction response comprises the instruction being executed as a no-operation instruction. In some examples the prohibited instruction response comprises the generation of an exception, wherein the security circuitry is configured to store information in a syndrome information register of the register circuitry indicative of a cause of the exception. In other examples the prohibited instruction response comprises causing the instruction to be transformed to execute as a modified instruction, e.g. a different instruction (i.e. one that is considered more benign). In still other examples the prohibited instruction response comprises causing an exception to be taken that is reported as though the instruction (i.e. its encoding) does not exist (i.e. it is “undefined”).

The use of various types of instruction may be prohibited by means of a permission disable of the set of permission disables. In some examples, the predetermined type of instruction is a supervisor call instruction configured to trigger an exception causing the apparatus to transition from an unprivileged mode to a privileged mode. In some examples, the predetermined type of instruction is a pointer authentication instruction configured to authenticate cryptographically validity of a pointer. In some examples, the predetermined type of instruction is a guarded control stack pointer modifying instruction configured to modify a guarded control stack pointer. In some examples, the predetermined type of instruction is an allocation tag storing instruction configured to store a security verification value in association with an allocated region of memory. In some examples, the predetermined type of instruction is an exception return instruction.

The restriction imposed by the permission disables of the set of permission disables may relate to the target location rather than the particular instruction seeking access to that target location. Thus in some examples, the instruction specifies the operation to be performed on a target location that is at least one bit of at least one selected register and the at least one permission disable of the set of permission disables causes the at least one bit of the at least one selected register to be read-only for the instruction.

In accordance with one example configuration there is provided a method comprising:
fetching, in response to an instruction fetch address, an instruction associated with the instruction fetch address;
holding values in registers indicative of a current processing state, wherein the registers comprises an execution context identifier register to hold an execution context identifier indicative of a current process which has caused the instruction to be fetched;
conditionally performing, in response to the instruction, an operation defined by the instruction;
determining, based on the instruction fetch address, a current region identifier;
determining, based on the current region identifier and the execution context identifier, a permissions index;
using the permissions index to index into a permissions disabling table to determine a set of permission disables;
determining, based on the set of permission disables, whether the operation is prohibited; and
issuing, in response to determining that the operation is prohibited, a response to the processing circuitry indicating that the operation is prohibited.

In accordance with one example configuration there is provided a computer program for controlling a host data processing apparatus to provide an instruction execution environment, the computer program comprising:
instruction fetch program logic responsive to an instruction fetch address to fetch an instruction associated with the instruction fetch address;
processing program logic responsive to the instruction conditionally to perform an operation defined by the instruction;
register program logic to hold values indicative of a current processing state of the processing circuitry, wherein the register circuitry comprises an execution context identifier register to hold an execution context identifier indicative of a current process which has caused the instruction to be fetched; and
security program logic configured to:
   determine, based on the instruction fetch address, a current region identifier;
   determine, based on the current region identifier and the execution context identifier, a permissions index;
   use the permissions index to index into a permissions disabling table to determine a set of permission disables;
   determine, based on the set of permission disables, whether the operation is prohibited; and
   issue, in response to determining that the operation is prohibited, a response to the processing program logic indicating that the operation is prohibited.

In accordance with one example configuration there is provided a computer-readable storage medium to store the above-defined computer program.

Particular embodiments will now be described with reference to the figures.

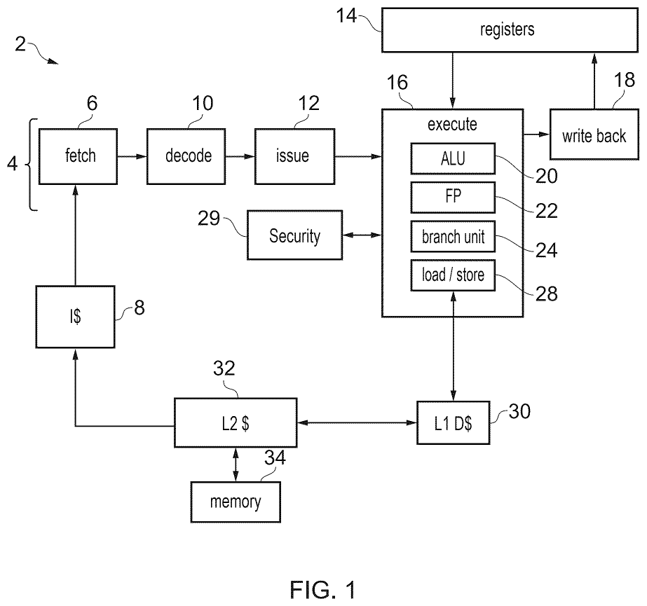

FIG. 1 illustrates a data processing apparatus 2 in accordance with some embodiments. The apparatus 2 has a processing pipeline 4 that includes a number of pipeline stages. In this example, the pipeline stages include: a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture and other systems may have additional stages or a different configuration of stages. For example, in an out-of-order processor an additional register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. In the example shown, the execution units include an arithmetic/logic unit (ALU) 20 for performing arithmetic or logical operations; a floating-point unit 22 for performing operations on floating-point values; a branch unit 24 for evaluating the outcome of branch operations and adjusting the program counter which represents the current point of execution accordingly; and a load/store unit 28 for performing load/store operations to access data in a memory system 8, 30, 32, 34. In this example, the memory system includes a level one data cache (L1D$) 30, a level one instruction cache (L1I$) 8, a shared level two cache (L2$) 32, and main system memory 34. It will be appreciated that this is just one example of a possible memory hierarchy and other arrangements of caches can be provided. Further shown is a security unit 29 that is configured to determine, for operations to be performed by the execute unit 16, whether the operations are permitted. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness, such as branch prediction mechanisms or address translation or other memory management mechanisms.

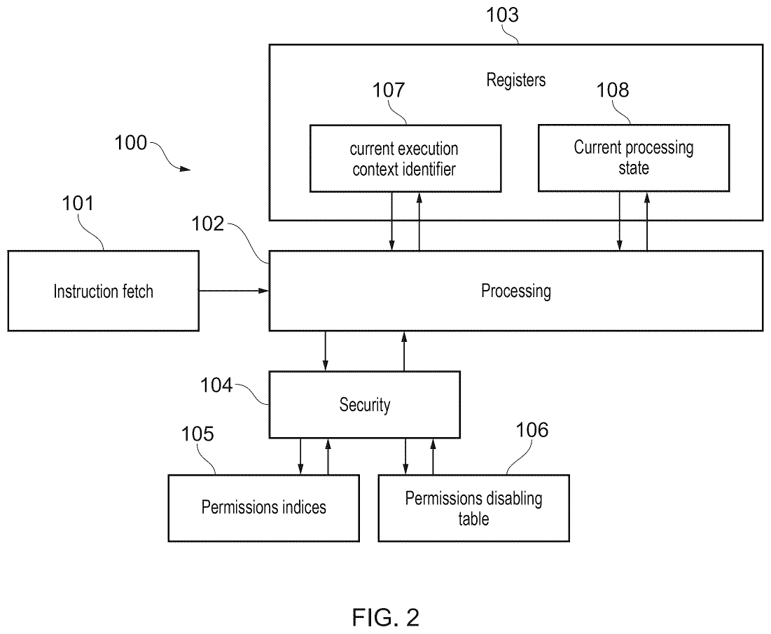

FIG. 2 schematically illustrates in more detail some key components of an example apparatus 100 in accordance with the present techniques. The apparatus 100 comprises instruction fetch circuitry 101 that is configured to fetch a sequence of instructions from the memory system for execution by the processing circuitry 102. In a manner with which the person of ordinary skill in the art will be familiar, the sequence of instructions fetched may be dictated by a program counter value corresponding to memory addresses at which those instructions are stored, whereby the program counter value is generally incremented to indicate the next instruction to be fetched and executed, except when it is caused to jump to a different section of program code, for example when a branch is encountered. Some of the instructions executed by the processing circuitry define an operation specifying a target register. Whether the processing circuitry is permitted to execute the instruction and/or to access the target register is controlled by the security circuitry 104. Data processing performed by the processing circuitry 102 comprises accessing data values temporarily stored in the registers 103. The registers 103 hold data values with a variety of purposes, for example whilst some register data values, such those in the current processing state register file 108, hold values indicative of a current processing state of the processing circuitry and dictate the current operational configuration of the apparatus, other register data values are obtained by retrieval from the memory system as the subject of the data processing operations that the processing circuitry carries out. When modified by the data processing operations these data values may then be written back to the memory system. The figure further shows the current execution context identifier register 107 that holds a current execution context identifier indicative of a current process that has caused the current instruction to be fetched. The security circuitry 104 is configured to determine, for a given instruction, whether that instruction itself is permitted to be executed or not, and whether a target register specified by the instruction is permitted to be accessed in the manner specified by the instruction, based on the originating particular process and program code, the execution of which comprises this instruction. To do this the security circuitry 104 firstly determines, based on the instruction fetch address, a current region identifier. It then determines a permissions index, based on the current region identifier and the execution context identifier provided by the current execution register 107. Permissions indices (from which the permissions index is selected) may be available to the security circuitry is a variety of ways as generally shown by the permissions indices block 105. The security circuitry 104 then uses the permissions index to index into a permissions disabling table 106 to determine a set of permission disables. Accordingly, the set of permission disables provides a fine-grained control over whether the subject operation is allowed or prohibited, in particular by enabling specific actions to be prohibited. Consequently, the security circuitry can then either allow the operation to proceed or signal a response to the processing circuitry indicating that the operation is prohibited.

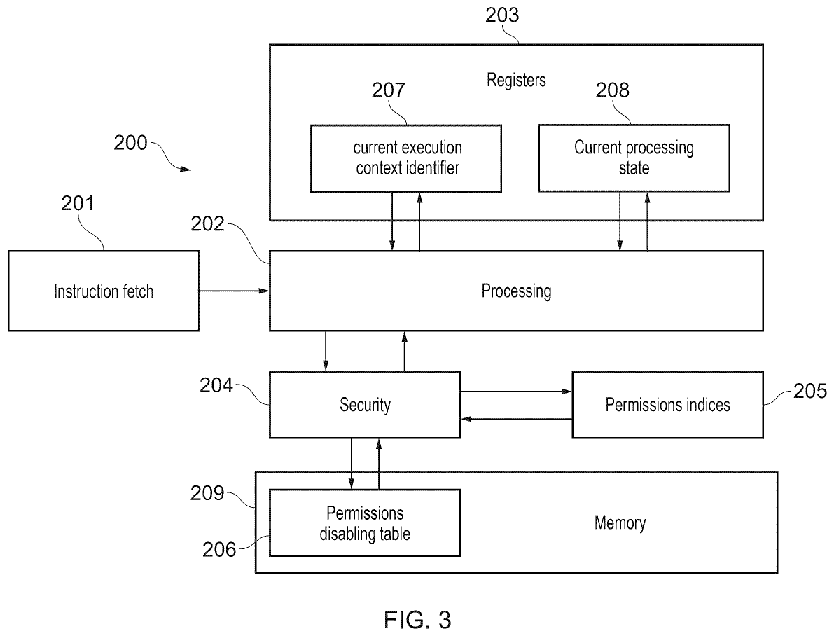

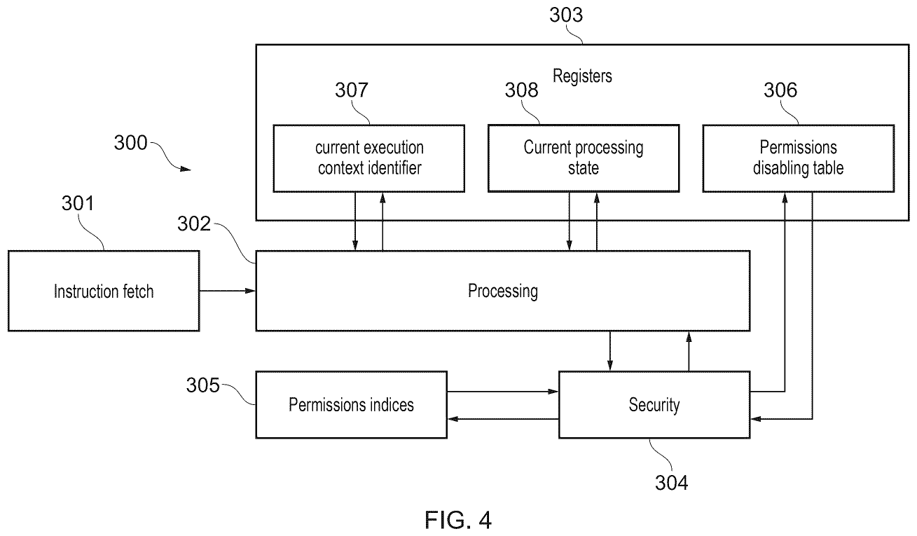

The permissions disabling table may be provided to be accessible to the security circuitry 104 in various ways. FIGS. 3 and 4 are similar to FIG. 2 and indeed within the apparatus 100/200/300, the instruction fetch circuitry 101/201/301, the processing circuitry 102/202/302, the current execution context identifier register 107/207/307, and the current processing state register 108/208/308 within the set of registers 103/203/303, and the permissions indices storage 105/205/305 are configured and operate as described with reference to FIG. 2. In the example of FIG. 3, the security circuitry 204 is arranged to access a permissions disabling table 206 that is stored in memory 209 and thus will be accessed by the security circuitry 204 via usual memory access mechanisms. In the example of FIG. 4, the security circuitry 304 is arranged to access a permissions disabling table that is stored in one or more registers 306 in the registers 303.

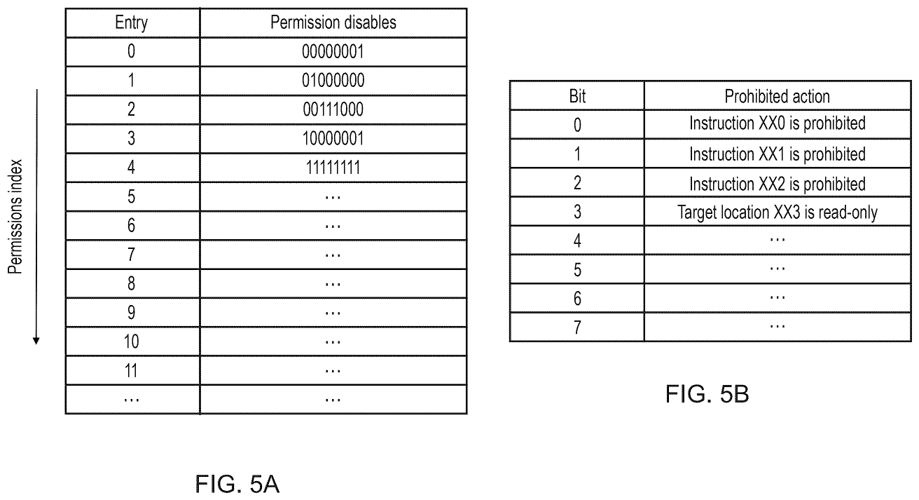

FIGS. 5A and 5B illustrate an example configuration of a permissions disabling table. FIG. 5A shows a permissions disabling table comprising multiple entries, whereby an entry of the permissions disabling table is selected by the use of the permissions index. Each entry comprises a data value, which in this illustrated example comprises 8 bits. The particular length of the data value is not significant and in other examples different data value lengths may be chosen. When the permissions disabling table is accessed (by means of indexing using the permissions index) the selected data value is retrieved. FIG. 5B illustrates the semantic interpretation of the data value, wherein each bit of the data value corresponds to a particular prohibited action. Examples are shown of the execution of particular instructions or instructions types being prohibited, as well as a specified target location being restricted to being read-only (where it would otherwise also be write-accessible). The present techniques are not limited to any particular set of prohibitions being defined to correspond to the bits of the data values of the permissions disabling table. Nevertheless, purely by way of example, the prohibitions could include:
A specific instruction (i.e. as characterised by a specific opcode)
A type of instruction (i.e. any instruction which meets the type definition)
Any instruction which initiates a specific type of action
Normal operation of a specific instruction or instruction type (e.g. the instruction is allowed to execute, but a defined response is triggered, such as the generation of an exception)
Certain registers (or certain bits of a specified register) may not be written to (i.e. are constrained to be read-only for the executing instruction).

By way of further example the (types of) instructions which may fall into at least one of the above prohibition categories may include:
a supervisor call instruction which is configured to trigger an exception that causes the apparatus to transition from an unprivileged mode to a privileged mode
a pointer authentication instruction that is configured to authenticate cryptographically the validity of a pointer
a guarded control stack pointer modifying instruction that is configured to modify a guarded control stack pointer
an allocation tag storing instruction that is configured to store a security verification value in association with an allocated region of memory
an exception return instruction

Any register may be subjected to the above-mentioned read-only constraint, but purely by way of example the registers may be translation-related registers, i.e. those that control aspects of address translation such as:
a translation table base register
a translation control register
a permission indirection register
a permission overlay register
an (auxiliary) memory attribute indirection register
a system control register

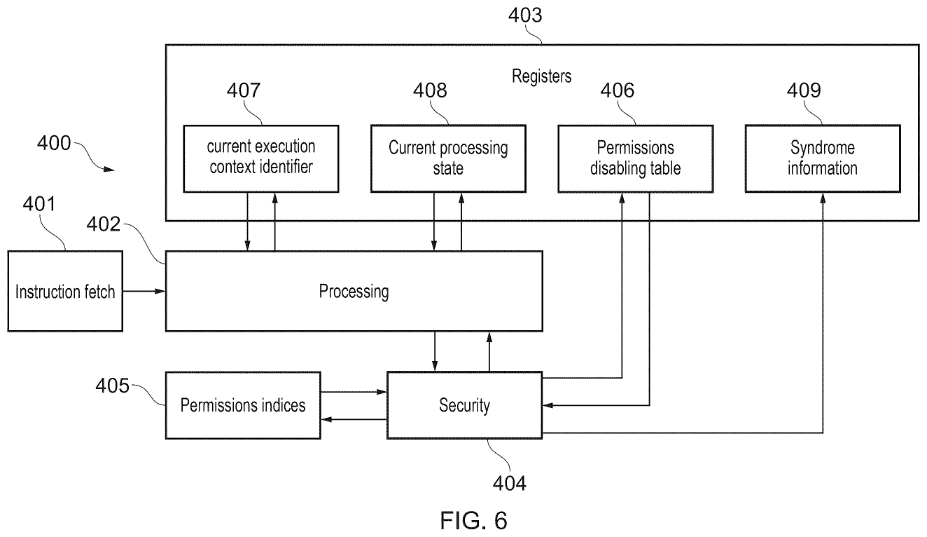

FIG. 6 schematically illustrates a further example configuration of an apparatus 400, which is also similar to the apparatus 100 of FIG. 2 and indeed the instruction fetch circuitry 101/401, the processing circuitry 102/402, the current execution context identifier register 107/407 and the current processing state register 108/408 within the set of registers 103/403, and the permission indices storage 105/405 are configured and operate as described with reference to FIG. 2. In the example of FIG. 6, the memory security circuitry 404 is arranged to access a permissions disabling table that is stored in one or more registers 406 in the registers 403. Also, in cases in which the memory security circuitry 404 determines the request is prohibited, the prohibited instruction response may comprise the generation of an exception and the security circuitry 404 can then store information in a syndrome information register 409 of the register circuitry 403 indicative of a cause of the exception. In other cases in which the memory security circuitry 404 determines the request is prohibited, the prohibited instruction response comprises causing the instruction to be transformed to execute as a different instruction (i.e. one that is considered more benign). In still other examples the prohibited instruction response comprises causing an exception to be taken that is reported as though the instruction (i.e. its encoding) does not exist (i.e. it is “undefined”).

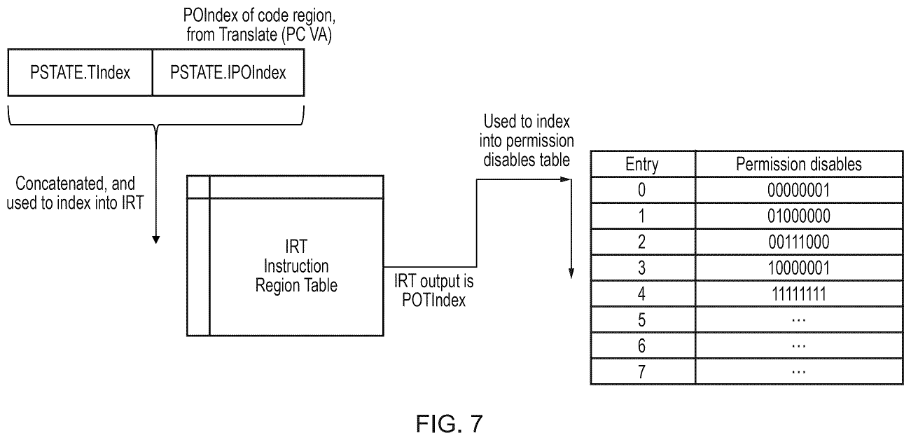

FIG. 7 illustrates the manner in which a permissions index is determined and used to index into a permissions disabling table in accordance with some examples. In a first stage the permissions index is determined, wherein information relating to the current process and the particular code being executed is used to determine a permissions index. To support this, memory pages are annotated (in their page table entries) with a permission overlay index (POIndex). Also, the processor state (here, PSTATE) held in the registers to define the current processing state is augmented by a temporal index field (TIndex). TIndex is controlled to correspond to the current execution context and, for example, is modified when the exception (privilege) level changes, such as on exception entry to a more privileged exception level or on legal exception return to a less privileged exception level. On exception entry/return without a change in exception level, TIndex is unchanged. The permission overlay index forms part of the translation information accessed when a virtual address is translated into a physical address. In the first stage, two identifiers PSTATE.TIndex and PSTATE.IPOIndex are derived. PSTATE.TIndex identifies what process is currently executing and PSTATE.IPOIndex (obtained by translating the program counter virtual address) identifies the particular code being executed. PSTATE.TIndex and PSTATE.IPOIndex are concatenated and used to index into an instruction region table (IRT). The IRT of this example is a one-dimensional table, with each entry comprising a permissions index (POTIndex). Note that there are distinct instruction region tables for each exception level. In the second stage the permissions index (POTIndex) is used to index into the permission disables table to select a set of permission disables (as described above with reference to FIGS. 5A and 5B).

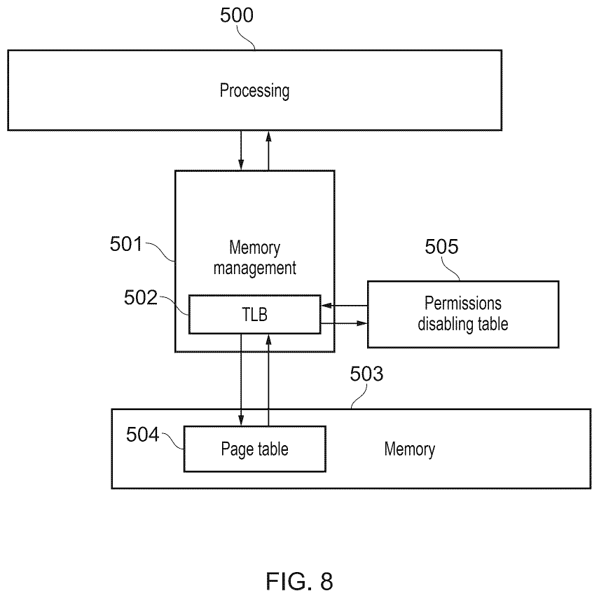

FIG. 8 schematically illustrates part of an apparatus comprising a memory management unit that controls access permissions in accordance with some examples. Access to memory initiated by instructions executed by the processing circuitry 500 are handled by the memory management unit (MMU) 501. The MMU 501 controls the process which translates virtual addresses (VA) used by the processing circuitry 500 into physical addresses used in the memory system being accessed. Page tables 504 stored in memory define the translations and further provide some access permissions associated with the regions of memory being accessed. Address translation information retrieved from the page tables is cached in the translation lookaside buffer (TLB) 502 in order to avoid the latency associated with a full page table walk (which is necessary the first time that a given translation is required) for repeatedly accessed memory locations. The MMU 501 determines a set of permissions information for access requests from the processing circuitry 500 that it handles. This set of permissions information may derive at least in part from page table access permissions information obtained from a page table entry of the page table 504. The application of the set of permission disables to the set of permissions information produces a reduced set of permissions information. Note that the permissions overlay information obtained from the POT can be variously combined with the page table derived access permissions. This combination can be additive, i.e. that any action permitted by either the page table derived access permissions or the permissions overlay information is allowed (unless prohibited by a permissions disable). Alternatively, the combination can be subtractive, i.e. that for an action to be allowed it must be permitted by both the page table derived access permissions and the permissions overlay information (and also not prohibited by a permissions disable).

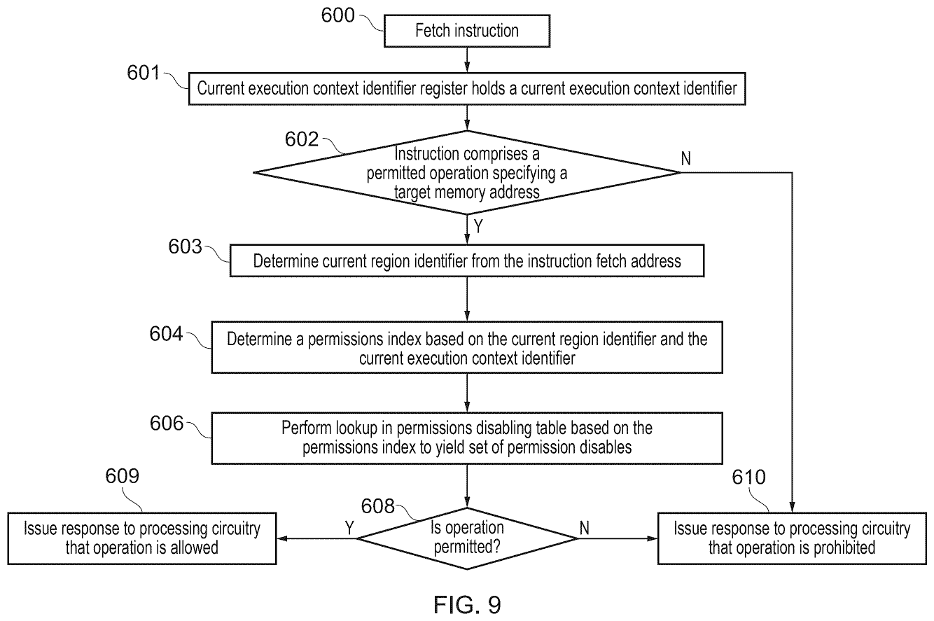

FIG. 9 is a flow diagram showing a sequence of steps which are taken in accordance with the method of some examples. The sequence shown begins at step 600 where an instruction is fetched and step 601 shows the current execution context identifier register holding a current execution context identifier. Next an optional step 602 may be present, at which it can be determined (e.g. by memory security circuitry) if the instruction comprises a permitted operation specifying a target memory address. This may for example be performed with reference to a corresponding page table entry indicating some access permissions for this target memory address. If at step 602 it is determined that the operation would be in violation of those access permissions then the flow proceeds directly to step 610 at which a response is issued (e.g. by the memory security circuitry) to the processing circuitry indicating that the operation is prohibited. When the access permissions permit the operation at the target memory address, the flow proceeds from step 602 to step 603 (or when step 602 is not present the flow proceeds directly from step 601 to step 603) at which a current region identifier is determined from the instruction fetch address. Then at step 604 a permissions index is determined based on the current region identifier and the current execution context identifier. Next at step 606 a look up in a permissions disabling table is performed using the permissions index to yield a set of permission disables information. It is then determined at step 608 whether the request is permitted to proceed. If it is not then the flow proceeds to step 610 at which a response is issued (e.g. by the memory security circuitry) to the processing circuitry indicating that the request is prohibited. When the request is permitted the flow proceeds to step 609, issuing a response to the processing circuitry that the request is allowed. Note that an explicit “allowed” notification at step 609 may be omitted, and the request is simply allowed to proceed.

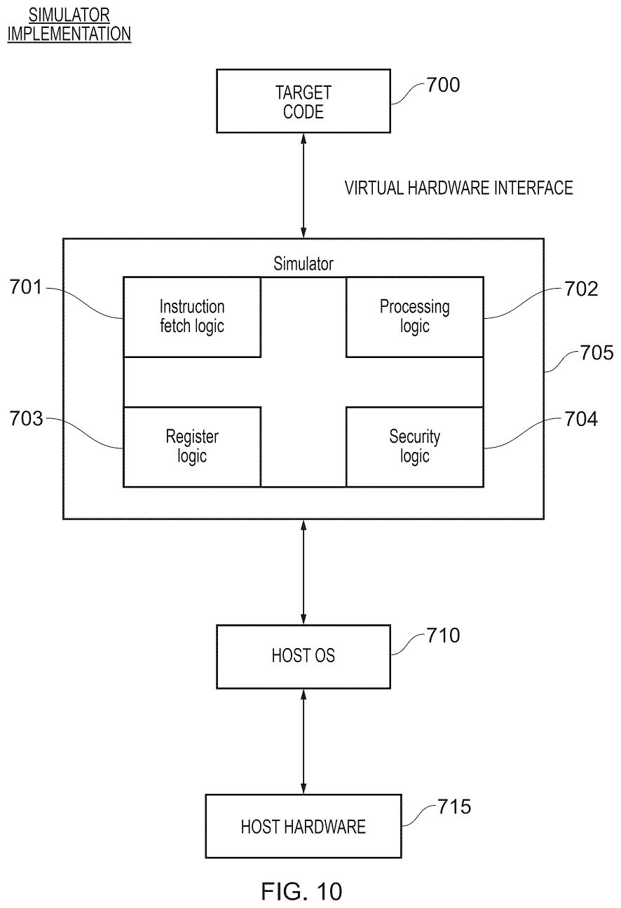

FIG. 10 schematically illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 715, optionally running a host operating system 710, supporting the simulator program 705. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality that is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 715), some simulated embodiments may make use of the host hardware, where suitable.

The simulator program 705 may be stored on a computer-readable storage medium (which may be a non-transitory medium), and provides a program interface (instruction execution environment) to the target code 700 (which may include applications, operating systems and a hypervisor) which is the same as the interface of the hardware architecture being modelled by the simulator program 705. Thus, the program instructions of the target code 700 may be executed from within the instruction execution environment using the simulator program 705, so that a host computer 715 which does not actually have the hardware features of the apparatuses discussed above can emulate these features, these being provided by instruction fetch logic 701, processing logic 702, register logic 703, and memory security logic 704.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Various configurations within the scope of the present disclosure are set out in the following numbered clauses.

Clause 1. Apparatus comprising:
instruction fetch circuitry responsive to an instruction fetch address to fetch an instruction associated with the instruction fetch address;
processing circuitry responsive to the instruction conditionally to perform an operation defined by the instruction;
register circuitry to hold values indicative of a current processing state of the processing circuitry, wherein the register circuitry comprises an execution context identifier register to hold an execution context identifier indicative of a current process which has caused the instruction to be fetched; and
security circuitry configured to:
   determine, based on the instruction fetch address, a current region identifier;
   determine, based on the current region identifier and the execution context identifier, a permissions index;
   use the permissions index to index into a permissions disabling table to determine a set of permission disables;
   determine, based on the set of permission disables, whether the operation is prohibited; and
   issue, in response to determining that the operation is prohibited, a response to the processing circuitry indicating that the operation is prohibited.

Clause 2. The apparatus of Clause 1, wherein the permissions disabling table is stored in memory and the security circuitry comprises table access circuitry to perform a look-up in the permissions disabling table in memory based on the permissions index to determine the set of permissions disables.

Clause 3. The apparatus of Clause 1, wherein the permissions disabling table is stored in one or more registers of the register circuitry and the security circuitry comprises table access circuitry to perform a look-up in the permissions disabling table in the one or more registers of the register circuitry based on the permissions index to determine the set of permissions disables.

Clause 4. The apparatus of any of Clauses 1-3, wherein the permissions disabling table stores a set of entries indexed by the permissions index, wherein each entry in the permissions disabling table is a multi-bit value, wherein each bit of the multi-bit value corresponds to an individual permission disable of the set of permission disables.

Clause 5. The apparatus of any of Clauses 1-4, wherein the security circuitry comprises table access circuitry to perform a look-up in an instruction region table in memory based on the current region identifier and the execution context identifier to determine the permissions index.

Clause 6. The apparatus of Clause 5, wherein the instruction region table is a one-dimensional table and the security circuitry is configured to concatenate the current region identifier and the execution context identifier to provide an index for the look-up in the instruction region table.

Clause 7. The apparatus of any of Clauses 1-6, wherein at least one permission disable of the set of permission disables causes the operation to be determined to be prohibited, when the instruction is a predetermined type of instruction.

Clause 8. The apparatus of Clause 7, wherein the security circuitry is responsive to the at least one permission disable of the set of permission disables causing the operation to be determined to be prohibited to initiate a prohibited instruction response.

Clause 9. The apparatus as defined in Clause 8, wherein the prohibited instruction response comprises the instruction being executed as a modified instruction.

Clause 10. The apparatus as defined in Clause 9, wherein the modified instruction is a no-operation instruction.

Clause 11. The apparatus as defined in any of Clauses 8-10, wherein the prohibited instruction response comprises the generation of an exception,
and wherein the security circuitry is configured to store information in a syndrome information register of the register circuitry indicative of a cause of the exception.

Clause 12. The apparatus of any of Clauses 7-11, wherein the predetermined type of instruction is a supervisor call instruction configured to trigger an exception causing the apparatus to transition from an unprivileged mode to a privileged mode.

Clause 13. The apparatus of any of Clauses 7-11, wherein the predetermined type of instruction is a pointer authentication instruction configured to authenticate cryptographically validity of a pointer.

Clause 14. The apparatus of any of Clauses 7-11, wherein the predetermined type of instruction is a guarded control stack pointer modifying instruction configured to modify a guarded control stack pointer.

Clause 15. The apparatus of any of Clauses 7-11, wherein the predetermined type of instruction is an allocation tag storing instruction configured to store a security verification value in association with an allocated region of memory.

Clause 16. The apparatus of any of Clauses 7-11, wherein the predetermined type of instruction is an exception return instruction.

Clause 17. The apparatus of any of Clauses 1-16, wherein the instruction specifies the operation to be performed on a target location that is at least one bit of at least one selected register and the at least one permission disable of the set of permission disables causes the at least one bit of the at least one selected register to be read-only for the instruction.

Clause 18. A method comprising:
fetching, in response to an instruction fetch address, an instruction associated with the instruction fetch address;
holding values in registers indicative of a current processing state, wherein the registers comprises an execution context identifier register to hold an execution context identifier indicative of a current process which has caused the instruction to be fetched;
conditionally performing, in response to the instruction, an operation defined by the instruction;
determining, based on the instruction fetch address, a current region identifier;
determining, based on the current region identifier and the execution context identifier, a permissions index;
   using the permissions index to index into a permissions disabling table to determine a set of permission disables;
determining, based on the set of permission disables, whether the operation is prohibited; and
issuing, in response to determining that the operation is prohibited, a response to the processing circuitry indicating that the operation is prohibited.

Clause 19. A computer program for controlling a host data processing apparatus to provide an instruction execution environment, the computer program comprising:
instruction fetch program logic responsive to an instruction fetch address to fetch an instruction associated with the instruction fetch address;
processing program logic responsive to the instruction conditionally to perform an operation defined by the instruction;
register program logic to hold values indicative of a current processing state of the processing circuitry, wherein the register circuitry comprises an execution context identifier register to hold an execution context identifier indicative of a current process which has caused the instruction to be fetched; and
security program logic configured to:
   determine, based on the instruction fetch address, a current region identifier;
   determine, based on the current region identifier and the execution context identifier, a permissions index;
   use the permissions index to index into a permissions disabling table to determine a set of permission disables;
   determine, based on the set of permission disables, whether the operation is prohibited; and
   issue, in response to determining that the operation is prohibited, a response to the processing program logic indicating that the operation is prohibited.

Clause 20. A computer-readable storage medium to store the computer program of Clause 19.

In brief overall summary apparatuses, methods, computer programs and computer-readable storage media are disclosed. An instruction associated with an instruction fetch address is fetched. In response to the instruction an operation defined by the instruction is conditionally performed. Values indicative of a current processing state of processing are held in registers comprising an execution context identifier register holding an execution context identifier indicative of a current process. A current region identifier is determined based on the instruction fetch address. A permissions index is determined based on the current region identifier and the execution context identifier. The permissions index is used to index into a permissions disabling table to determine a set of permission disables and whether or not the operation is prohibited is determined based on the set of permission disables.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware that provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

We claim:

1. Apparatus comprising:
instruction fetch circuitry responsive to an instruction fetch address to fetch an instruction associated with the instruction fetch address;
processing circuitry responsive to the instruction conditionally to perform an operation defined by the instruction;
register circuitry to hold values indicative of a current processing state of the processing circuitry, wherein the register circuitry comprises an execution context identifier register to hold an execution context identifier indicative of a current process which has caused the instruction to be fetched; and
security circuitry configured to:
determine, based on the instruction fetch address, a current region identifier;
determine, based on the current region identifier and the execution context identifier, a permissions index;
use the permissions index to index into a permissions disabling table to determine a set of permission disables;
determine, based on the set of permission disables, whether the operation is prohibited; and
issue, in response to determining that the operation is prohibited, a response to the processing circuitry indicating that the operation is prohibited.

2. The apparatus of claim 1, wherein the permissions disabling table is stored in memory and the security circuitry comprises table access circuitry to perform a look-up in the permissions disabling table in memory based on the permissions index to determine the set of permissions disables.

3. The apparatus of claim 1, wherein the permissions disabling table is stored in one or more registers of the register circuitry and the security circuitry comprises table access circuitry to perform a look-up in the permissions disabling table in the one or more registers of the register circuitry based on the permissions index to determine the set of permissions disables.

4. The apparatus of claim 1, wherein the permissions disabling table stores a set of entries indexed by the permissions index, wherein each entry in the permissions disabling table is a multi-bit value, wherein each bit of the multi-bit value corresponds to an individual permission disable of the set of permission disables.

5. The apparatus of claim 1, wherein the security circuitry comprises table access circuitry to perform a look-up in an instruction region table in memory based on the current region identifier and the execution context identifier to determine the permissions index.

6. The apparatus of claim 5, wherein the instruction region table is a one-dimensional table and the security circuitry is configured to concatenate the current region identifier and the execution context identifier to provide an index for the look-up in the instruction region table.

7. The apparatus of claim 1, wherein at least one permission disable of the set of permission disables causes the operation to be determined to be prohibited, when the instruction is a predetermined type of instruction.

8. The apparatus of claim 7, wherein the security circuitry is responsive to the at least one permission disable of the set of permission disables causing the operation to be determined to be prohibited to initiate a prohibited instruction response.

9. The apparatus as defined in claim 8, wherein the prohibited instruction response comprises the instruction being executed as a modified instruction.

10. The apparatus as defined in claim 9, wherein the modified instruction is a no-operation instruction.

11. The apparatus as defined in claim 8, wherein the prohibited instruction response comprises the generation of an exception,
and wherein the security circuitry is configured to store information in a syndrome information register of the register circuitry indicative of a cause of the exception.

12. The apparatus of claim 7, wherein the predetermined type of instruction is a supervisor call instruction configured to trigger an exception causing the apparatus to transition from an unprivileged mode to a privileged mode.

13. The apparatus of claim 7, wherein the predetermined type of instruction is a pointer authentication instruction configured to authenticate cryptographically validity of a pointer.

14. The apparatus of claim 7, wherein the predetermined type of instruction is a guarded control stack pointer modifying instruction configured to modify a guarded control stack pointer.

15. The apparatus of claim 7, wherein the predetermined type of instruction is an allocation tag storing instruction configured to store a security verification value in association with an allocated region of memory.

16. The apparatus of claim 7, wherein the predetermined type of instruction is an exception return instruction.

17. The apparatus of claim 1, wherein the instruction specifies the operation to be performed on a target location that is at least one bit of at least one selected register and the at least one permission disable of the set of permission disables causes the at least one bit of the at least one selected register to be read-only for the instruction.

18. A method comprising:
fetching, in response to an instruction fetch address, an instruction associated with the instruction fetch address;
holding values in registers indicative of a current processing state, wherein the registers comprises an execution context identifier register to hold an execution context identifier indicative of a current process which has caused the instruction to be fetched;
conditionally performing, in response to the instruction, an operation defined by the instruction;
determining, based on the instruction fetch address, a current region identifier;
determining, based on the current region identifier and the execution context identifier, a permissions index;
using the permissions index to index into a permissions disabling table to determine a set of permission disables;
determining, based on the set of permission disables, whether the operation is prohibited; and
issuing, in response to determining that the operation is prohibited, a response to the processing circuitry indicating that the operation is prohibited.

19. A computer program for controlling a host data processing apparatus to provide an instruction execution environment, the computer program comprising:
instruction fetch program logic responsive to an instruction fetch address to fetch an instruction associated with the instruction fetch address;
processing program logic responsive to the instruction conditionally to perform an operation defined by the instruction;
register program logic to hold values indicative of a current processing state of the processing circuitry, wherein the register circuitry comprises an execution context identifier register to hold an execution context identifier indicative of a current process which has caused the instruction to be fetched; and
security program logic configured to:
determine, based on the instruction fetch address, a current region identifier;
determine, based on the current region identifier and the execution context identifier, a permissions index;
use the permissions index to index into a permissions disabling table to determine a set of permission disables;
determine, based on the set of permission disables, whether the operation is prohibited; and
issue, in response to determining that the operation is prohibited, a response to the processing program logic indicating that the operation is prohibited.

20. A computer-readable storage medium to store the computer program of claim 19.
